(19) United States
(12) Patent Application Publication
(10) Pub. No.: US 2023/0242779 A1
(43) Pub. Date: Aug. 3, 2023

(54) CROSSLINKED COPOLYMER, PREPARATION METHOD AND PRINTING PASTE COMPRISING SAID COPOLYMER

(71) Applicant: SPCM SA, Andrezieux Boutheon (FR)

(72) Inventors: Frédéric BLONDEL, Andrezieux Boutheon (FR); Hadrien CHOLLAT-NAMY, Andrezieux Boutheon (FR); Rémi THIBAL, Andrezieux Boutheon (FR)

(21) Appl. No.: 18/010,529

(22) PCT Filed: Jun. 24, 2021
(86) PCT No.: PCT/FR2021/051157

§ 371 Date: Dec. 15, 2022

(30) Foreign Application Priority Data
Jun. 25, 2020 (FR) 2006646

(51) Int. Cl. C09D 11/107; C08F 220/06; C09D 11/328; D06P 5/30; D06P 5/00; D06P 1/54

(52) U.S. Cl. CPC C09D 11/107; C08F 220/06; C09D 11/328; D06P 5/30; D06P 5/001; D06P 1/54; C08F 2800/10; C08F 2810/20

(57) ABSTRACT

The present invention relates to a crosslinked copolymer obtained by precipitation polymerization of at least one monomer comprising at least one carboxylic acid function, at least one hydrophobic monomer, and at least one crosslinking agent. The copolymer is mainly characterized in that 30 mol % to 90 mol % of the carboxylic acid functions are in salified form prior to the precipitation polymerization, the solvent used for the precipitation polymerization comprises at least one alcohol comprising 1 to 4 carbon atoms, and the copolymer is obtained in the absence of water-soluble non-ionic monomers.

### FIELD OF THE INVENTION

The invention relates in particular to the field of acrylic thickeners. More specifically, the invention relates to a crosslinked copolymer based on monomers comprising a carboxylic acid function, in particular an acrylic acid function. Another aspect of the invention relates to a method for the preparation of said crosslinked copolymer. Another aspect of the invention relates to a printing paste comprising this crosslinked copolymer, as well as a method for preparing such a printing paste.

### PRIOR ART

The U.S. Pat. No. 4,722,958 describes a method for preparing acrylamide/acrylic acid/alkyl methacrylate copolymers in which the acid functions are completely neutralized, i.e. in salified form prior to the polymerization step. The presence of acrylamide allows precipitating the copolymer once the polymerization is complete. Nonetheless, these polymers have the drawback of containing acrylamide which reduces the anionic charge of the final polymer and its thickening performances. Moreover, the preparation of these polymers requires handling of a monomer that is dangerous to health and brings in nitrogen functions, the presence of which in the effluents of textile factories tends to be increasingly regulated and limited. In addition, in the case of a precipitation polymerization, the acrylamide must be used in its pure powder form, which makes handling complicated and risky.

The U.S. Pat. No. 6,696,508 describes formulations based on acrylic acid polymers obtained by precipitation polymerization (acronym PPP) and formulated in oily dispersion in a natural solvent. During use, these polymers or copolymers of acrylic acid are in non-neutralized form and must be neutralized by the addition of a base into the liquid formulation. In this case, the acrylic acid polymer is neutralized by bubbling with ammonia in the dispersion. Hence, this operation is a complex additional step, which requires time and industrial means suited to this specific method type. In the case where a base other than ammonia is used to adjust the pH of the formulation, such as carbonate or hydrogen carbonate, for example, stability problems arise due to sedimentation of the used base or a release after a few days of carbon dioxide resulting from the neutralization of the polyacrylic acid functions.

Document EP0161038 describes a method for preparing a hydrophobic or water swellable polymer which implements a step of neutralizing the carboxylic acid functions of an anionic monomer. This method is carried out by inverse emulsion polymerization, in a hydrocarbon solvent, from unsaturated acid monomers comprising free acid functions and salified acid functions, and from a crosslinking agent.

Moreover, during printing of a textile material with a printing paste based on acrylic acid, the apparition of a white veil is sometimes observed at the surface of the printed textile material. This problem, which is well known to a person skilled in the art, is called icing or “frosting”, and is due to the insufficient retention of the printing paste at the surface of the textile material during printing. The top of the yarns of the textile, or of the bristles in the case of a carpet for example, is then no longer covered by the colored paste and remains white, which produces this undesirable surface effect.

The present invention allows overcoming the drawbacks of the prior art. In particular, the invention aims to prepare a crosslinked copolymer without using acrylamide, while preserving and even improving the thickening properties of this copolymer compared to those of the prior art.

### DISCLOSURE OF THE INVENTION

According to a first aspect, the invention relates to a crosslinked copolymer obtained by precipitation polymerization of at least:
60 mol % to 99.8 mol % of at least one anionic monomer comprising at least one carboxylic acid function,
0.1 mol % to 20 mol % of at least one hydrophobic monomer of formula (I), R₂R₃C═CR₁X,

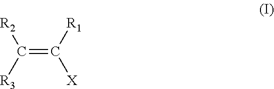

wherein:
R₁, R₂ and R₃ are, independently of each other, a hydrogen atom or a methyl group,
X is a group C(═O)—O—Y or CH₂—C(═O)—O—Y, wherein Y is a hydrocarbon group, saturated or unsaturated, linear, branched or cyclic, possibly aromatic, comprising 3 to 30 carbon atoms, comprising from 3 to 30 heteroatoms selected from among the group comprising O, N, and S,
1×10⁻⁹ mol % to 2 mol % of at least one crosslinking agent.

The cross-linked copolymer is mainly characterized in that 30% to 90% of carboxylic acid functions of the anionic monomer are neutralized, i.e. in salified form, prior to the precipitation polymerization, and in that the solvent used for the precipitation polymerization is composed of at least one alcohol comprising 1 to 4 carbon atoms, and in that the crosslinked copolymer is obtained in the absence of water-soluble non-ionic monomers.

All molar percentages are expressed relative to the total number of moles of monomers including the crosslinking agent.

According to one embodiment, the sum of the molar percentages of the anionic monomer comprising at least one carboxylic acid function, of the hydrophobic monomer of formula (I), and of the crosslinking agent, is equal to 100 mol %.

The combination of the characteristics of the copolymer of the invention, namely (1) the presence of 60 mol % to 99.8 mol % of the anionic monomer comprising at least one carboxylic acid function, (2) the presence of 0.1 mol % to 20 mol % of the hydrophobic monomer of formula (I), (3) the precipitation polymerization, (4) the neutralization of 30% to 90% of the carboxylic acid functions of the anionic monomer prior to the polymerization, and (5) the use of an alcohol comprising 1 to 4 carbon atoms, leads to a synergistic effect which allows obtaining a crosslinked copolymer having thickening properties at least equivalent to those of copolymers of the prior art, while dispensing with acrylamide.

In addition, the copolymer of the invention has the advantage of avoiding the phenomenon of icing, when it is used in a printing paste to carry out printing of a textile material.

According to one embodiment, the crosslinked copolymer of the invention is obtained by precipitation polymerization, in the presence of a crosslinking agent, of the following monomers only: 60 mol % to 99.8 mol % of said at least one anionic monomer comprising at least one carboxylic acid function, and from 0.1 mol % to 20 mol % of said at least one hydrophobic monomer of formula (I). In other words, according to this embodiment, the obtained crosslinked copolymer comprises only the anionic monomer and the hydrophobic monomer of formula (I) as constituent monomers. A person skilled in the art will know how to adjust the molar percentages of these two monomers in order to reach 100% relative to the total number of moles of monomers and crosslinker.

Advantageously, the crosslinked copolymer according to the invention does not comprise any additional anionic monomer that would be different from the anionic monomer comprising at least one carboxylic acid function. In other words, the crosslinked copolymer according to the invention comprises anionic charges which, advantageously, originate exclusively from the anionic monomer comprising at least one carboxylic acid function.

In the present text, the term “water-soluble” refers to a compound (in particular a monomer) forming an aqueous solution without insoluble particles when it is added under stirring for 4 hours at 25° C. at a concentration of 20 g·L⁻¹ in the deionized water.

On the contrary, a “hydrophobic” compound is not water-soluble. Thus, it forms a precipitate when it is added in solid form and under stirring for 4 hours at 25° C. at a concentration of 20 g·L⁻¹ in deionized water.

Precipitation polymerization in a solvent medium consists in the polymerization of soluble monomers in a solvent whereas the obtained copolymer is insoluble, and therefore precipitates in the solvent. The feasibility of this type of polymerization may optionally be ensured by the presence of particular tensioactive agents (or surfactants) conferring the fluidity suited to the dispersion medium.

According to one embodiment, the copolymer is obtained from at least one anionic monomer comprising at least one carboxylic acid function, from at least one hydrophobic monomer of formula (I), from at least one cationic monomer and from at least one crosslinking agent.

Preferably, the anionic monomer comprising at least one carboxylic acid function is selected from among acrylic acid, methacrylic acid, itaconic acid, crotonic acid, maleic acid and fumaric acid. Acrylic acid and methacrylic acid are most preferred, especially acrylic acid.

The copolymer comprises from 60 to 99.8 mol % (molar percentage) of at least one anionic carboxylic acid monomer, preferably from 78 to 99.8 mol %, more preferably from 85 to 99.8 mol %, even more preferably from 88 to 99.8 mol %.

According to one embodiment, the carboxylic acid functions of the anionic monomer are salified by a salifying agent, also called neutralizing agent. As already indicated, 30% to 90 mol % of the carboxylic acid functions of the copolymer are neutralized, more advantageously 40% to 90%.

The salification is carried out prior to the polymerization by precipitation. Of course, this is the percentage of number of neutralized C(═O)OH functions relative to the total number of C(═O)OH functions of the monomers present before the start of the polymerization.

Advantageously, the salifying agent is a Brønsted base. Preferably, it is selected from among ammonia, sodium carbonate, potassium carbonate, ammonium carbonate, sodium bicarbonate, potassium bicarbonate, ammonium bicarbonate, and mixtures thereof. Quite particularly, ammonia is preferred.

The hydrophobic monomer is of formula (I):

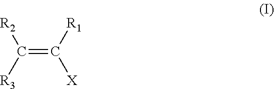

wherein:

R₁, R₂ and R₃ are, independently of each other, a hydrogen atom or a methyl group, X is a C(═O)—O—Y group,

wherein Y is advantageously a hydrocarbon group, saturated or unsaturated, linear or branched, comprising 15 to 25 carbon atoms.

According to a particular embodiment, the hydrophobic monomer is of formula (I) wherein:

R₁ is a methyl group, R₂ and R₃ are hydrogen atoms,

X is a C(═O)—O—Y group,

wherein Y is a linear alkyl chain of 18 carbon atoms (C₁₈H₃₇).

Preferably, the copolymer comprises from 0.1 to 13 mol %, more preferably from 0.1 to 10 mol % of monomer of formula (I).

Optionally, the copolymer may comprise one or more cationic monomer(s). In particular, the cationic monomer(s) may be selected from among monomers of the acrylamide, acrylic, vinyl, allylic or maleic type, having a quaternary ammonium function. In particular and without limitation, mention may be made of quaternized dimethylaminoethyl acrylate (DMAEA), quaternized dimethylaminoethyl methacrylate (DEAEMA), dimethyldiallylammonium chloride (DADMAC), acrylamido propyltrimethyl ammonium chloride (APTAC), and methacrylamido propyltrimethyl ammonium chloride (MAPTAC).

More preferably, the copolymer according to the invention is obtained in the absence of water-soluble non-ionic monomers selected from among acrylamide, methacrylamide; N-isopropylacrylamide; N,N-dimethylacrylamide; N,N diethylacrylamide; N-methylolacrylamide; N-vinylformamide; N-vinyl acetamide; N-vinylpyridine; N-vinylpyrrolidone; acryloyl morpholine, and diacetone acrylamide.

The copolymer is prepared in the presence of at least one crosslinking agent. Preferably, the crosslinking agent is selected from among the group comprising polyethylenically unsaturated monomers (having at least two unsaturated functions), such as vinyl, allylic, acrylic and epoxy functions which are found in particular in methylene bis acrylamide (MBA), or triallyamine, or by macroinitiators such as polyperoxides, polyazos and polytransfer agents such as polymercaptants polymers for example.

Optionally, the crosslinked copolymer is prepared in the presence of at least one chain transfer agent, which is preferably selected from among the group comprising chain transfer agents, of the phosphate type, such as sodium hypophosphite, alcohols, such as methanol or isopropanol, based on thiol, such as 2-mercaptoethanol and mixtures of the preceding agents.

Preferably, the solvent used for the precipitation polymerization is an alcohol comprising 1 to 4 carbons. Advantageously, it is selected from among methanol, ethanol, propan-1-ol, isopropanol, tert-butanol or mixtures thereof. Preferably, the used solvent is tert-butanol.

According to a particular embodiment, the polymerization may be carried out in the presence of water. The solvent may comprise up to 10% by weight of water, preferably up to 5% by weight of water.

According to another aspect, the invention relates to a method for preparing a copolymer as described above, by precipitation polymerization. The method is mainly characterized in that it comprises the following steps:
preparing a reaction medium comprising at least one solvent and from 5% to 35% by weight of at least one monomer comprising at least one carboxylic acid function,
salifying 30 mol % to 90 mol % of the carboxylic acid functions of the monomer comprising at least one carboxylic acid function, by the addition of a salifying agent,
introducing 0.01% to 20% by weight of at least one hydrophobic monomer of formula (I) and of 1×10⁻⁶% to 2% by weight of at least one crosslinking agent in the reaction medium,
polymerizing the monomers comprising at least one carboxylic acid function and hydrophobic monomers of formula (I), to obtain the copolymer.

The mass percentages described above, namely 5% to 35% by weight of at least one monomer comprising at least one carboxylic acid function, from 0.01% to 20% by weight of at least one hydrophobic monomer of formula (I), and 1×10⁻⁶% to 2% by weight of at least one crosslinking agent, are expressed relative to the final reaction medium, which comprises the monomer comprising at least one carboxylic acid function, the hydrophobic monomer of formula (I), the crosslinking agent, and the solvent.

According to the invention, the monomers and the crosslinking agent advantageously represent up to 36% by weight of the (final) reaction medium, preferably up to 31% by weight, more preferably up to 25% by weight.

Once the reaction is complete, the obtained copolymer forms a precipitate within the reaction medium.

Preferably, once the polymerization is complete, the copolymer is separated from the reaction medium.

The monomer concentration comprising at least one carboxylic acid function in the reaction medium is preferably comprised between 5% and 30% by weight relative to the reaction medium.

The concentration of hydrophobic monomer of formula (I) in the reaction medium is preferably comprised between 0.01% and 15% by weight relative to the reaction medium.

The concentration of crosslinking agent in the reaction medium is preferably comprised between 1×10⁻⁶% and 1.5% by weight relative to the (final) reaction medium.

The polymerization reaction is initiated by introducing a free radical initiator. As example of a free radical initiating agent, mention may be made of oxidant-reducer pairs with, among oxidants, cumene hydroperoxide or tertiary butylhydroxyperoxide, and among reducers, persulfates such as sodium metabisulphite and Mohr's salt. Azo compounds such as 2,2′-azobis(isobutyronitrile) and 2,2′-azobis(2-amidinopropane) hydrochloride can also be used.

Once the polymerization is complete, the copolymer appears in the reaction medium in the form of a precipitate. In general, it consists of a white precipitate. It can be easily isolated using the usual methods of separation, evaporation and drying. The solvent can be removed by filtering or distillation.

According to another aspect, the invention relates to a printing paste comprising at least one copolymer as described above.

Preferably, such a printing paste is a pigmented printing paste or a fixed-washed printing paste, used for applying pigments or dyes respectively over a textile material.

Preferably, the printing paste contains at least one dye (fixed-washed printing paste) or at least one pigment (pigment printing paste).

Preferably, the amount of copolymer in the printing paste is comprised between 0.1% and 5% by weight relative to the weight of the printing paste, more advantageously between 1% and 5%.

Other components may be present in the printing paste, such as acids bases and/or natural or synthetic salts to adjust the pH to the desired value; anionic, non-ionic or cationic surfactants; antifoam and antifreeze agents; dispersing agents; hydrophobic latexes/binders; setting agents; polyhydroxy compounds; reaction products of hydroxy compounds and isocyanates; polyesters prepared by reaction of terephthalic acid and one or more polyethylene glycol(s). These components are commonly used or recommended for textile printing or finishing.

The copolymer can be used in powder form or in dispersion form. The dispersion form is obtained by introducing the obtained powder into an organic oil.

The organic oil can be of vegetable, animal or mineral origin. The chemistry of this oil can be ester, fatty acid, linear or branched alkane chain, paraffin derivative, or it can be a mixture of several ones of these oils.

Preferably, the organic oil has a flash point above 50° C. (advantageously below 400° C.) and a melting point below 15° C. (advantageously above −100° C.).

In addition to the organic oil, one or more wax(es) with a higher melting point can also be used, advantageously at 0% to 20% by weight relative to the weight of the dispersion. The use of this type of wax allows improves the stability of the dispersion by increasing the viscosity of the medium.

The dispersion may comprise at least one water-in-oil surfactant with an HLB (Hydrophilic Lipophilic Balance) comprised between 1 and 6 in order to stabilize the dispersion and to improve the dispersion of the copolymer in the oil.

The HLB value is determined according to the Griffin method (Classification of Surface-Active Agents by HLB, Journal of the Society of Cosmetic Chemists 1 (1949): 311).

Preferably, the water-in-oil surfactant(s) are selected from among esters prepared from alcohols of the glycerol, diglecerol or triglycerol type, or alcohols of the saccharide type such as maltinol or sorbitol. These polyols can be subject to single esterifications such as sorbitan monooleate or to multiple esterifications. Preferably, sorbitan esters are used.

The dispersion can also comprise at least one oil-in-water surfactant with an HLB greater than or equal to 7 in order to enable the dispersion to release the copolymer once diluted in water.

Preferably, the oil-in-water surfactant(s) are selected from among ethoxylated fatty alcohol type ethers, saccharide or polyhydric alcohol esters or betaines. Preferably, ethoxylated alcohols are used.

According to another aspect, the invention relates to a method for printing a textile material using a printing paste comprising at least one copolymer as described before. The method comprises the following steps:
preparing a printing paste by mixing at least one crosslinked copolymer as described before and at least one dye or at least one pigment,
applying the printing paste over a textile material.

According to one embodiment, the textile material to be printed is advantageously made of natural or synthetic polyamide, polyamine, polypropylene, polyester, silk, wool, viscose, rayon, cotton or a wool/polyamide mixture. Preferably, the textile materials are advantageously made of polyamide, polyester, polypropylene, wool or a wool/polyamide mixture.

Preferably, the printing method is carried out on substrates of the rug or carpet type comprising a textile material, said textile material preferably being selected from among those described before.

The printing paste according to the invention can be applied in a conventional manner using different printing methods, such as screen-printing and digital spray printing (spraying), for example.

Screen-printing consists in applying ink using a mesh stretched in a frame or screen, using a layer or mask, thus producing a color print directly on the textile.

Digital spray printing consists in spraying microdrops of ink over a textile support via an inkjet print head.

As regards digital spray printing, mention may be made for example of Chromojet (zimmer), Millitron (Milliken) and Atexco (Hangzhou Honghua Digital Technology). Digital spray printing differs from conventional digital printing in that the printing paste is kept under pressure and sprayed over the substrate in a sufficient amount to cover and penetrate it in depth.

In the case of Zimmer and Atexco technology, for example, a printing nozzle based on the principle of a piezoelectric valve opens and closes to start/resume or stop the depositon of ink over the textile.

In Milliken's technology, for example, the ink jet is permanent and deviated either onto the substrate to apply color or into a collector connected to the ink supply. All of the printing methods noted hereinabove require a particular viscosity and a rheological profile of the printing paste in order to obtain the desired printing performances.

Digital printing differs from screen-printing by an electronically controlled system that deposits ink over specific areas of the substrate. This system is used to print any type of material such as paper, woven or knitted fabrics.

Preferably, the method for printing textile material according to the invention uses the digital spray printing method.

The examples hereinafter illustrate non-limiting embodiments of the invention.

### EXAMPLES OF EMBODIMENTS OF THE INVENTION

Protocol for the Preparation of a Copolymer (A-O) by Precipitation Polymerization

654 g of pure tert-butanol are mixed in a reactor with 16.77 g of water in order to obtain a mixture comprising 97.5% by weight of tert-butanol. Afterwards, acrylic acid is added into the reactor. Afterwards, the acrylic acid is neutralized by addition of gaseous ammonia until obtaining a pH comprised between 6 and 6.5. Once this pH has been obtained, stearyl methylacrylate and MBA (N,N-methylene-bis-acrylamide) are added. The preparation is degassed in the reactor by injecting nitrogen. Afterwards, 18.75 ppm of HTPO (4-hydroxy-2,2,6,6-tetramethylpiperidine-N-oxyl) are added and the temperature of the reactor is maintained at 70° C. using a thermostated bath. The polymerization reaction is initiated by adding 0.32 g of V50 (2,2′-azobis[2-methylpropionamidine],dichlorhydrate) and 0.64 g of VA044 (2,2′-[azobis(1-methylethylidene)]bis[4,5-dihydro-1H-imidazole dihydrochloride]). In general, the initiation of the polymerization is observed after 1 to 8 minutes. The thermostated bath is adjusted at 90° C. for 2 hours.

The presence of a white precipitate in the solvent is observed. This white precipitate corresponds to the copolymer of the invention. The latter is separated from the solvent by distillation using a rotary evaporator with oil heated to 90° C. and under a reduced pressure of 700 mbar. Afterwards, the copolymer obtained in powder form is placed in an oven for 12 hours at 70° C.

The copolymers A to O are prepared according to the protocol hereinbefore. The amounts of the different monomers are adjusted in order to obtain the proportions indicated in Table 1 hereinbelow for each example.

Preparation of the Polymer P

The polymer P is prepared according to the protocol hereinbefore, i.e. by precipitation polymerization, but without using stearyl methacrylate (MAS).

Preparation of the Polymer Q

The polymer Q is prepared according to the following protocol, by inverse emulsion polymerization.

The ingredients of the aqueous phase are loaded into a 1 L beaker under magnetic stirring:
310 g of deionized water
217 g of acrylic acid
168 g of ammonia in 30% solution
13.33 g of stearyl methylacrylate
0.696 g of methylenebisacrylamide (2400 ppm)

Afterwards, in a 1 L glass reactor, under mechanical stirring, the organic phase is prepared with:
133.5 g of paraffinic mineral oil (celtis 903)
133.5 g of aliphatic hydrocarbon (Isopar L)
22.5 g of sorbitan monooleate.

The aqueous phase is progressively transferred into the organic phase. Thus, the formed pre-emulsion is then subjected to high shear for 45 seconds (Ultra Turrax, IKA).

The inverse emulsion is then degassed for 30 minutes by simple nitrogen bubbling.

An aqueous solution containing 0.5% by weight of sodium metabisulphite and another solution containing 0.35% by weight of TBHP are added at a flow rate of 10 mL/h for a period of 60 minutes. Once the maximum temperature has been reached, the temperature of the reaction mixture is maintained for 60 minutes before cooling.

Afterwards, the polymer is isolated by precipitation in acetone.

Preparation of the Polymer R

The polymer R is prepared according to the protocol for the polymer Q, but without using stearyl methacrylate (MAS).

The results are indicated in Table 1 hereinbelow.

TABLE 1
Summary of tests and characteristics

| | | Monomer (mol %) | | | | | | | | |
|---|---|---|---|---|---|---|---|---|---|---|
| | | | | | MBA | Neutralization | Characteristics | | | |
| | | AA | ACM | MAS | *10⁻⁴ | (%) | Precipitation^{(c)} | Viscosity^{(a)} | Dispersion^{(d)} | pH^{(b)} |
| Counter- | A | 29.68 | 69.67 | 0.65 | 2,400 | — | good | 2,700 | difficult | 3.6 |
| examples | B | 49.68 | 49.67 | 0.65 | 2,400 | — | good | 2,860 | difficult | 3.6 |
| | C | 30.00 | 70.00 | — | 2,400 | — | good | 2,300 | difficult | 3.6 |
| | D | 50.00 | 50.00 | — | 2,400 | — | good | 2,500 | difficult | 3.6 |
| | E | 100.00 | — | — | 2,400 | — | no | impossible | impossible | na |
| | F | 99.35 | — | 0.65 | 2,400 | — | no | impossible | impossible | na |
| | G | 99.35 | — | 0.65 | 2,400 | 15 | no | impossible | impossible | na |
| | H | 99.35 | — | 0.65 | 2,400 | 20 | no | impossible | impossible | na |
| | I | 99.35 | — | 0.65 | 2,400 | 100* | no | impossible | impossible | — |
| | J | 99.35 | — | 0.65 | 2,400 | 100** | good | 17,000 | easy | 7.3 |
| Invention | K | 99.35 | — | 0.65 | 2,400 | 35 | good | 4,600 | easy | 5.3 |
| | L | 99.35 | — | 0.65 | 2,400 | 40 | good | 14,860 | easy | 5.5 |
| | M | 99.35 | — | 0.65 | 2,400 | 50 | good | 19,750 | easy | 5.8 |
| | N | 99.35 | — | 0.65 | 2,400 | 75 | good | 22,500 | easy | 6.2 |
| | O | 99.35 | — | 0.65 | 2,400 | 90 | good | 29,500 | easy | 6.7 |
| Counter- | P | 100 | — | — | 2,400 | 75 | good | 18,500 | — | 6.2 |
| examples | Q | 99.35 | — | 0.65 | 2,400 | 75 | — | 2,600 | — | 6.2 |
| | R | 100 | — | — | 2,400 | 75 | — | 2,500 | — | 6.2 |

AA: acrylic acid
ACM: acrylamide
MAS: stearyl methacrylate
MBA: in ppm relative to the weight of the monomers
*post-neutralized = acrylic acid neutralized after polymerization
**pre-neutralized = acrylic acid neutralized before polymerization
^{(a)}Viscosity (mPa/s) is measured at 0.5% by weight of copolymer in deionized water at 25° C., with a Brookfield RV module viscometer at a speed of 20 revolutions per minute.
^{(b)}The pH is measured at 1% by weight of copolymer in deionized water at 25° C.
^{(c)}The precipitation is evaluated visually according to the apparition or not of a precipitate.
^{(d)}The dispersion is considered easy when dispersion is complete in less than 10 minutes under (three blade) stirring at 500 rpm in a beaker of 300 ml of water at 25° C. for a polymer concentration of 0.5% by weight.

As described before, all molar percentages are expressed relative to the total number of moles of monomers including the crosslinking agent. This is also the case for all of the polymers in Table 1. However, in order to simplify reading of the results, the concentration values (mol %) have been rounded to the hundredth for the monomers and to the ten thousandth for the crosslinking agent.

In case of 100% pre-neutralization of acrylic acid, the final pH (pH=7.3) is too high for a carpet printing application requiring a pH preferably in the range of 5.6 to 6.5 to enable setting of the dyes. Hence, a 100% neutralization requires a subsequent pH adjustment for use as a printing paste thickener.

For all examples, the total amount of monomers and crosslinking agent is equal to 15.5% by weight, relative to the total mass of the (final) reaction medium.

Printing Paste Preparation Protocol

498 g of deionized water and 2 g of acid black dye MR 125% (from Evron dyestuff) are added to a beaker. The whole is mixed then the copolymer, as a thickener, is added under stirring to thicken the mixture forming a printing paste. The amount of copolymer is determined in order to obtain a final viscosity of the printing paste of 2,500 mPa/s, measured with a Brookfield RV module viscometer at a speed of 20 revolutions per minute at 25° C.

On a Chromojet HSV 400 type laboratory digital printing system, the printing pastes obtained from the copolymers J to O are tested on their ability to pass through the printing nozzles in a given time.

This capacity to be able to transfer a sufficient amount of printing paste conditions the level of color obtained when printing a pattern on a textile, and the level of productivity of the printing step.

To carry out this test for each printing paste, the print head is ordered to continuously open for 15 seconds and the transferred printing paste is collected in a collector. The amount of printing paste transferred during this elapsed time is then weighed. The obtained results are indicated in Table 2 hereinbelow.

TABLE 2
application examples using different copolymers

| | | Amount of | Amount of |
|---|---|---|---|
| | Neutraliza- | thickener in | transferred |
| Polymer | tion % | g/kg of paste | paste (in g) |
| J | 100% | 4.12 | 70 |
| K | 35% | 4.63 | 102 |
| L | 40% | 4.67 | 105 |
| M | 50% | 4.51 | 99 |
| N | 75% | 4.28 | 97 |
| O | 90% | 4.2 | 92 |
| P | 75% | 4.6 | 94 |
| Q | 75% | 11.2 | 61 |
| R | 75% | 11.1 | 62 |

As one could notice, the amount of transferred printing paste drops sharply when the neutralization rate is between 90% and 100% neutralization before polymerization.

Yet, as described before, the amount of deposited printing paste is essential in this textile printing application because it directly impacts the obtained level of color.

Consequently, based on the results of Table 2, one could notice that a neutralization of the acrylic acid comprised between 30 and 90% allows maximizing the amount of printing paste transferred onto the textile substrate and therefore improving the quality and productivity of the printing method compared to those of the prior art.

Through these results, one could deduce that the neutralization rate directly impacts the rheological profile of the copolymer.

As regards the polymer P (counterexample), an amount of transferred paste close to the polymers K to O of the invention is obtained. Nevertheless, on application, a white veil is observed at the surface of the printed textile. This reflects the icing or “frosting” phenomenon, frequently observed in the methods known to a person skilled in the art when printing a textile material with a printing paste based on acrylic acid. As described before, this phenomenon is mainly due to insufficient holding of the printing paste at the surface of the textile during printing.

Moreover, one could clearly notice that the synthesis by inverse emulsion polymerization (Q and R polymers) leads to a product consuming much more polymer to obtain the target viscosity, and leads to polymers that considerably limit the transfer of paste through a printing nozzle. In particular, the polymer R corresponds to Example 2A of the document EP0161038 described at the beginning of the text, which relates to a polymer obtained by inverse emulsion polymerization of acrylic acid/ammonium acrylate in the presence of MBA as a crosslinking agent, with the exception of the 40/60 ratio of acrylic acid/ammonium acrylate.

Thus, the preceding examples demonstrate the synergy of the characteristics of the copolymer of the invention, namely (1)-(2) the presence of the anionic monomer and the hydrophobic monomer of formula (I) in the described concentration ranges, (3) the precipitation polymerization, (4) the neutralization of 30% to 90% of the carboxylic acid functions of the anionic monomer prior to the polymerization, and (5) the use of an alcohol comprising 1 to 4 carbon atoms, in obtaining a crosslinked copolymer having thickening properties at least equivalent to those of copolymers of the prior art, while dispensing with acrylamide, and that being so, without any glazing phenomenon.

1. A crosslinked copolymer obtained by precipitation polymerization of at least:
60 mol % to 99.8 mol % of at least one anionic monomer comprising at least one carboxylic acid function,
0.1 mol % to 20 mol % of at least one hydrophobic monomer of formula (I), 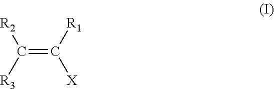
wherein:
R₁, R₂ and R₃ are, independently of each other, a hydrogen atom or a methyl group,
X is a group C(═O)—O—Y or CH₂—C(═O)—O—Y,
wherein Y is a hydrocarbon group, saturated or unsaturated, wherein Y is linear, branched, cyclic, or aromatic, wherein Y comprises 3 to 30 carbon atoms, and from 0 to 4 heteroatoms selected from the group consisting of O, N, and S,
1*10⁻⁹ mol % to 2 mol % of at least one crosslinking agent,
the crosslinked copolymer being having 30 mol % to 90 mol % of the carboxylic acid functions of the anionic monomer in salified form prior to the precipitation polymerization,
the solvent used for the precipitation polymerization comprising at least one alcohol comprising 1 to 4 carbon atoms, and
the copolymer being obtained in the absence of water-soluble non-ionic monomers.

2. The crosslinked copolymer according to claim 1, wherein the copolymer is obtained in the absence of water-soluble non-ionic monomers selected from acrylamide, methacrylamide, N-isopropylacrylamide, N,N-dimethylacrylamide, N,N diethylacrylamide, N-methylolacrylamide, N-vinylformamide, N-vinyl acetamide, N-vinylpyridine, N-vinylpyrrolidone, acryloyl morpholine or diacetone acrylamide.

3. The crosslinked copolymer according to claim 1, wherein the monomer comprising at least one carboxylic acid function is selected from the group consisting of acrylic acid, methacrylic acid, itaconic acid, crotonic acid, maleic acid and fumaric acid.

4. The crosslinked copolymer according to claim 1, wherein the monomer comprising at least one carboxylic acid function is acrylic acid.

5. The crosslinked copolymer according to claim 1, wherein the carboxylic acid functions are salified with a salifying agent selected from the group consisting of ammonia, sodium carbonate, potassium carbonate, ammonium carbonate, sodium bicarbonate, potassium bicarbonate, ammonium bicarbonate, and mixtures thereof.

6. The crosslinked copolymer according to claim 5, wherein the salifying agent is ammonia.

7. The crosslinked copolymer according to claim 1 wherein the copolymer is obtained by precipitation polymerization of 0.1 mol % to 10 mol % of the hydrophobic monomer of formula (I).

8. The crosslinked copolymer according to claim 1 wherein the hydrophobic monomer is of formula (I) wherein:
R₁ is a methyl group, R₂ and R₃ are hydrogen atoms,
and X is a group C(═O)—O—Y,
wherein Y is a linear alkyl chain of 18 carbon atoms.

9. A method for preparing a crosslinked copolymer according to claim 1 by precipitation polymerization, comprising:
preparing a reaction medium comprising at least one solvent and from 5% to 35% by weight of at least one monomer comprising at least one carboxylic acid function,
salifying 30 mol % to 90 mol % of the carboxylic acid functions of the monomer comprising at least one carboxylic acid function by the addition of a salifying agent,
introducing 0.01% to 20% by weight of at least one hydrophobic monomer of formula (I) and 1×10⁻⁶% to 2% by weight of at least one crosslinking agent into the reaction medium,
polymerizing monomers comprising at least one carboxylic acid function and hydrophobic monomers of formula (I) to obtain the crosslinked copolymer.

10. A printing paste comprising at least one crosslinked copolymer according to claim 1.

11. The printing paste according to claim 10, wherein the amount of crosslinked copolymer in the printing paste is comprised between 0.1% and 5% by weight.

12. A method for printing a textile material using a printing paste according to claim 10.

13. The method for printing a textile material according to claim 12, comprising the following steps:
preparing a printing paste by mixing at least one crosslinked copolymer according to claim 1 with at least one dye or at least one pigment, and
applying the printing paste over a textile material.

14. The method for printing a textile material according to claim 12 wherein the textile material is selected from natural polyamides, synthetic polyamides, polyamine, polypropylene, polyester, silk, wool, viscose, rayon, cotton, or a wool/polyamide mixture.
